(19) United States
(12) Patent Application Publication
(10) Pub. No.: US 2013/0227846 A1
(43) Pub. Date: Sep. 5, 2013

(54) Rafter Angle Square With Scribe Guide Notches

(71) Applicant: JOHNSON LEVEL & TOOL MFG. CO., INC., Mequon, WI (US)

(72) Inventor: Paul H. Buzzell, Milwaukee, WI (US)

(73) Assignee: Johnson Level & Tool Mfg. Co., Inc., Mequon, WI (US)

(21) Appl. No.: 13/772,828

(22) Filed: Feb. 21, 2013

Related U.S. Application Data
(60) Provisional application No. 61/605,482, filed on Mar. 1, 2012.

(51) Int. Cl. B43L 7/02

(52) U.S. Cl. CPC B43L 7/02
USPC 33/32.2

(57) ABSTRACT

A rafter angle square includes a first, ruler side, a second fence side, and a hypotenuse side extending between the ruler and fence sides to form a right triangle. The tool includes a front side and a back side and a number of markings on the front and back sides for carrying out measurements and other operations with the tool. The tool includes a scribe guide arrangement having a slot defining opposing edges. The edges include a number of projections extending toward the opposing edge and defining a number of scribe guide notches between adjacent projections. The scribe guide notches of the opposing edges are aligned with one another and configured to enable a user of the tool to mark a workpiece in a first and second, opposing direction parallel with an edge of the workpiece at the same distance from the edge of the workpiece.

### CROSS-REFERENCE TO RELATED APPLICATIONS

This application claims priority to U.S. Provisional Patent Application No. 61/605,482 filed on Mar. 1, 2012 and entitled Rafter Angle Square with Scribe Guides, the entirety of which is hereby incorporated by explicit reference thereto.

### BACKGROUND OF THE INVENTION

This invention relates to a rafter angle square and, more particularly, to a rafter angle square including a number of aligned scribe guide notches.

Rafter angle square tools, sometimes colloquially referred to as speed squares, are triangularly shaped tools combining the features and functions of a combination square, try square, and framing square into a single tool. A rafter angle square allows the user to quickly mark rafter angles without making the necessary mathematical calculations, and is commonly employed by framers and carpenters.

A rafter angle square is typically constructed of a generally planar body in the form of an isosceles right triangle with a ruler on one of the short sides and a pair of flanges, forming a fence, on the other. The rafter angle square is marked with the word “pivot” at the right angle of the triangle, which corresponds to a pivot point of the tool during use. Degrees are displayed along the hypotenuse side and common and/or hip/val marks on its midsection. The degree markings indicate an angle in degrees from 0-90 degrees. The common markings indicate the rise in inches over a 12-inch run for common rafters from 1-30 inches. The hip/val markings indicate the rise in inches over a 12-inch run for hip or valley rafters from 1-30 inches. Some rafter angle squares include notches or divots for accommodating a writing utensil such as a pencil to mark the workpiece to which the tool is applied.

A base defined by the fence side of the rafter angle square may be generally T-shaped, formed by the pair of flanges extending in opposite directions from the body, for holding the rafter angle square tool flush against an edge of the workpiece. To mark the workpiece with a desired angle, the body is placed on the surface of the workpiece and one of the flanges of the fence is brought into engagement with the edge of the workpiece. To make a cross-cut mark on the workpiece, a marking instrument is moved along the hypotenuse edge of the rafter angle square to mark a 45 degree angle or along the short, ruler edge of the rafter angle square to mark a 90 degree angle. To create marks of varying angles, the tool is rotated about its pivot point until the desired angle is aligned with the edge of the workpiece and then the marking instrument is moved along the ruler edge to mark the desired angle.

The rafter angle square is similarly used to make common and hip/valley rafter markings on the workpiece. To do this, one of the flanges of the fence of the rafter angle square is held against the workpiece, and the rafter angle square is pivoted about its pivot point until the appropriate measurement for the rise/run of the common or hip/val markings is aligned with the edge of the workpiece. The marking instrument is then moved along the edge of the rafter angle square to mark the workpiece.

A rafter angle square also typically includes scribe guide notches to enable a user to draw straight lines parallel to an edge of the workpiece. The scribe guide notches are typically defined by a number of teeth formed in a slot formed in the body of the rafter angle square that extends parallel to the ruler side of the body. To mark a line using the scribe guide notches, one of the flanges of the fence is held against the edge of the workpiece. A marking instrument is then inserted into the desired notch of the scribe guide on the side of the slot toward which the line is to be marked, and the rafter angle square tool is slid along the workpiece while holding the flange of the fence firmly to the edge of the workpiece and the marking instrument in the desired notch. This moves the marking instrument along with the rafter angle square, and results in a line that is parallel to the edge of the workpiece.

However, common rafter angle squares suffer from a number of known disadvantages. In particular, the scribe guide notches on one side of the scribe guide slot are arranged in an offset manner relative to the scribe guide notches on the opposing side of the slot. While this arrangement allows scribe guide notches to be placed at relatively fine increments, it has a significant practical drawback. Specifically, the offset nature of the scribe guide notches makes it difficult for a user to mark lines using the scribe guide notches in both directions without flipping the rafter angle square over. That is to say, if a line is to be scribed at a distance that corresponds with a notch that is located on the side of the slot away from the direction in which the rafter angle square is to be drawn, the square must be flipped over so that the notch is positioned on the correct side of the slot, i.e. the side of the slot toward the direction in which the rafter angle square is to be moved. The offset nature of the opposing scribe notches also does not allow a user to first mark by moving the square in a first direction and then mark a second line, coincident with the first line, in a second direction opposite the first direction.

Accordingly, a rafter angle square including aligned scribe guide notches on opposing sides of the scribe guide notch is desirable.

### SUMMARY OF THE INVENTION

The present invention is generally directed to a square, such as a rafter angle square having generally triangular body, which may be in the form of an isosceles triangle. The square has a fence element configured to assist the user in positioning the square flush against the edge of a workpiece, such as a board, piece of lumber, or the like. The square defines a ruler edge extending perpendicularly relative to the fence, and a hypotenuse edge extending opposite the intersection of the ruler edge and the fence element. The square further has a scribe slot formed in the body, which may extend generally parallel to the ruler side. The scribe slot has opposing sides defining a number of inwardly extending projections, which define a number of scribe guide notches between adjacent projections. The scribe guide notches of the opposing sides are aligned with one another, which enables a user to mark a line with the same distance from the edge of the workpiece by moving the square in either a first direction or in a second direction without flipping or otherwise repositioning the square and while maintaining the fence of the square in engagement with the edge of the workpiece.

A method of using a square, such as a rafter angle square having a scribe guide slot, is also contemplated. The method involves providing a square with a scribe guide slot that includes first and second opposing edges including a number of projections defining aligned scribe guide notches, in which the scribe guide notches of the first edge are aligned with the scribe guide notches of the second edge. In the method of using the square, the user positions a marking instrument in one of the scribe guide notches of the first edge and slidably move the rafter angle square along the edge of the workpiece to mark a line in a first direction parallel to the edge of the workpiece. The user may also position the marking instrument in the opposing scribe guide notch of the second edge and slidably move the square along the edge of the workpiece to mark a second line in a second direction opposite the first direction but still parallel with the edge of the workpiece and coincident with the first line.

Various other features, objects and advantages of the present invention will be made apparent from the following detailed description and the drawings.

### BRIEF DESCRIPTION OF THE DRAWINGS

The drawings illustrate preferred representative embodiment presently contemplated for carrying out the invention.

In the drawings:

FIG. 1 is an isometric view of a square, in the form of a rafter angle square, constructed in accordance with the present invention;

FIG. 2 is a top plan view of the rafter angle square of FIG. 1;

FIG. 3 is a bottom plan view of the rafter angle square of FIG. 1;

FIG. 4 is a side elevation view showing a fence side of the rafter angle square of FIG. 1;

FIG. 5 is a side elevation view showing a hypotenuse side of the rafter angle square of FIG. 1;

FIG. 6 is a side elevation view showing a ruler side of the rafter angle square of FIG. 1; and

FIG. 7 is an end elevation view of the rafter angle square of FIG. 1.

### DETAILED DESCRIPTION

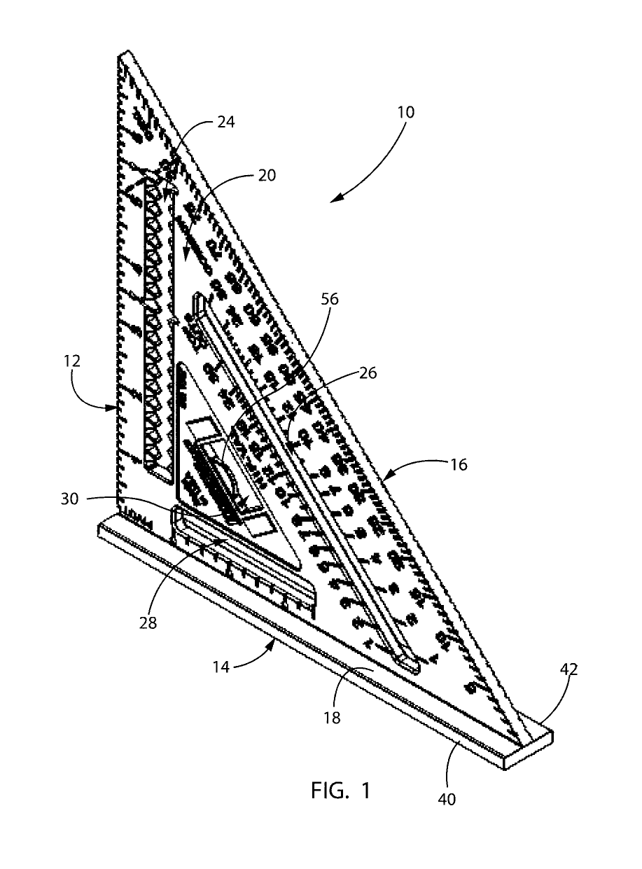

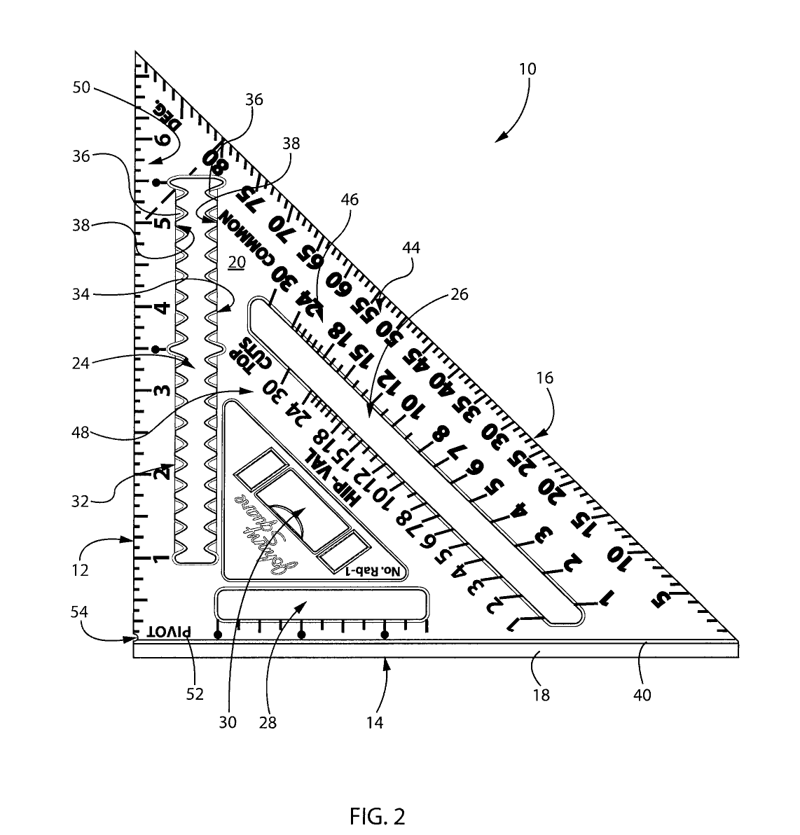

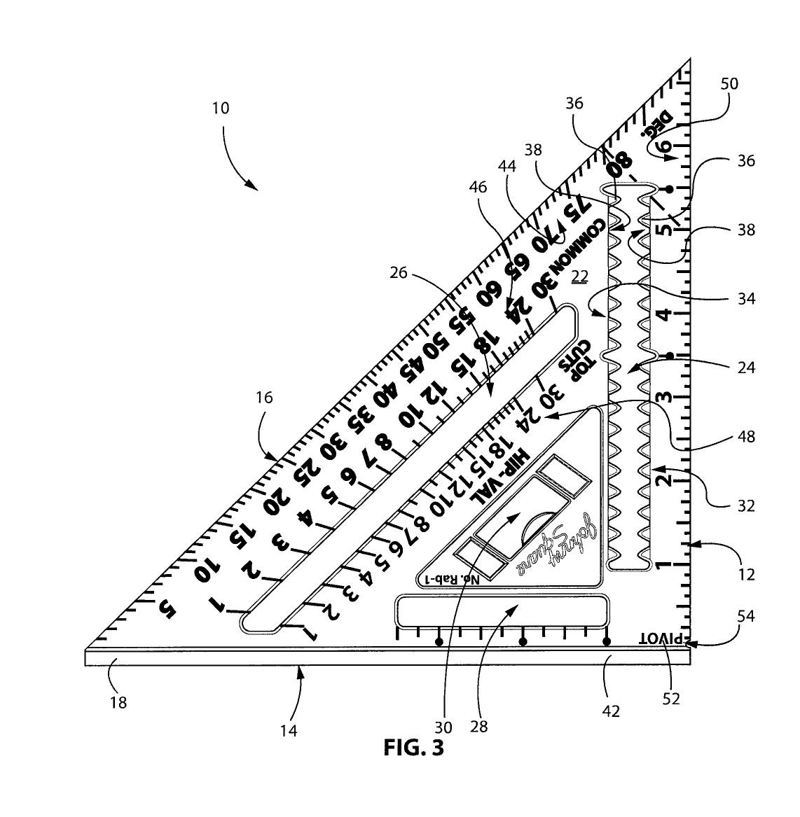

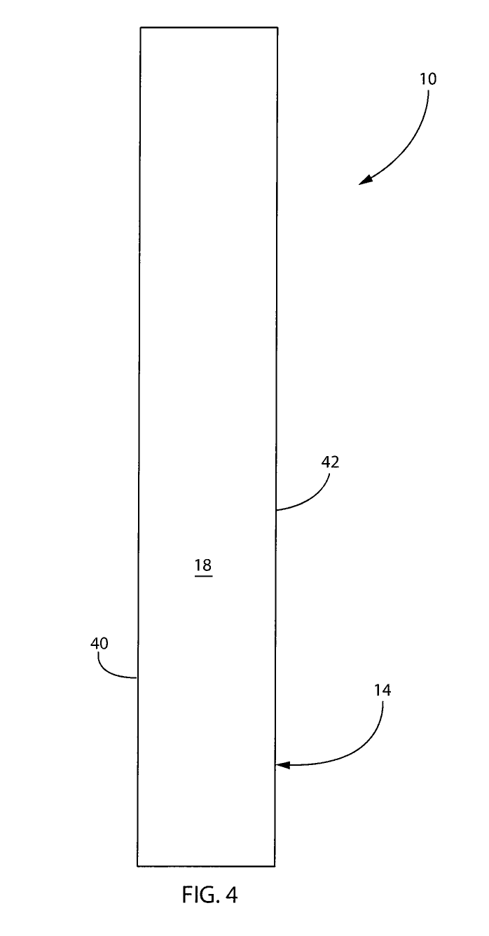

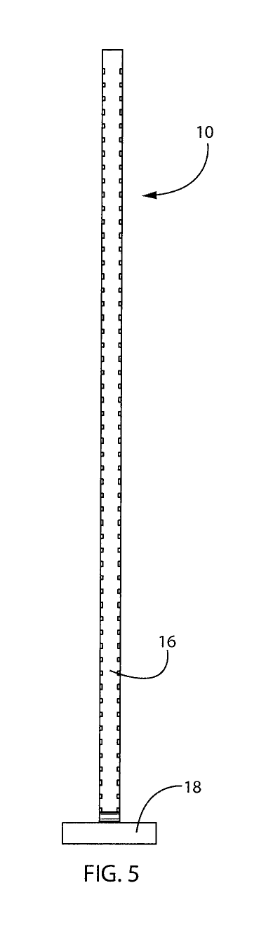

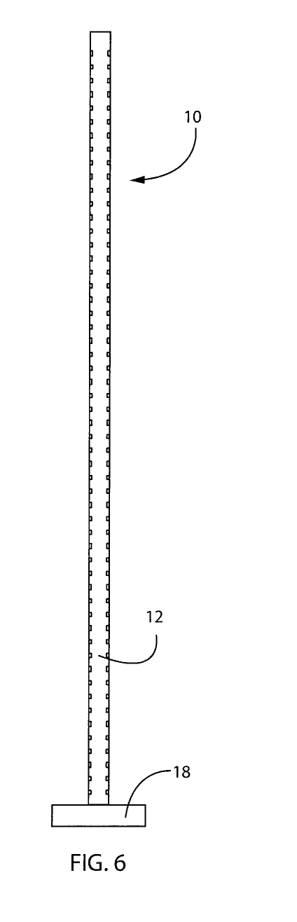

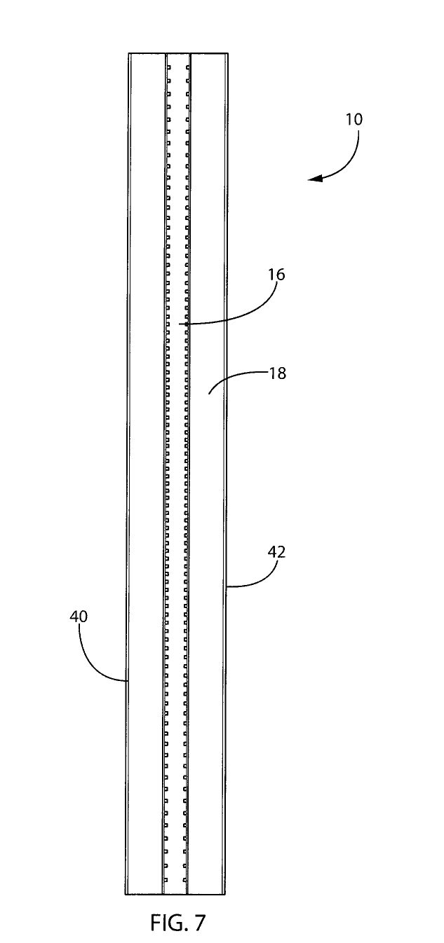

Referring now to the drawings and FIGS. 1-7, according to at least one construction of the present invention, a square, which may be in the form of a rafter angle square, is illustrated at 10. The square 10 is configured for measuring, drawing straight lines, and/or laying out angles on workpieces such as boards for use in constructing roofs, stairways, decks, and the like. The rafter angle square 10, may be constructed from plastic, metal, or any other suitable material. The square 10 is in the form of a body defining an isosceles right triangle including a first or ruler side 12 and a second or fence side 14 of equal length and a third or hypotenuse side 16. The fence side 14 may include a pair of flanges that extend in opposite directions from the edge of the body to form a fence element 18 arranged 90 degrees relative to the fence side 14 and configured to enable the user of the square 10 to position the square 10 flush against an edge of the workpiece. The fence element 18 forms a T-shaped base with the ruler side 12, wherein the fence element 18 serves as the horizontal portion of the T-shaped base and is configured to at least partially overlap an edge of the workpiece with a segment of the horizontal portion of the T-shaped base.

The square 10 includes a face side 20 and an opposing bottom side 22. The face and bottom sides 20 and 22 may include a number of markings for use in carrying out operations using the square 10 as will be described herein.

The square 10 defines a number of apertures or slots configured to enable the user to make a number of markings for carrying out a number of operations as will be explained. The square 10 includes a scribe guide slot 24, which may be formed so as to extend parallel to and adjacent the ruler side 12. The square 10 may further include a rafter slot 26, which may be formed so as to extend parallel to the hypotenuse side 16 and which may be formed in a midsection of the body of square 10. The square 10 also includes a fence slot 28, which may be formed so as to extend parallel to and generally adjacent the fence side 14, and an auxiliary slot 30, which may be formed at any number of locations on the square 10 as long as it does not interfere with operation of the square 10. As will be described in further detail herein, the scribe guide slot 24 enables the user of the square 10 to draw lines parallel to fence side 14 and the edge of the workpiece. The rafter slot 26 enables the user to mark the workpiece at a desired slope with respect to either common or hip/val rafter construction. The fence slot 28 enables the user to measure and/or mark lines parallel with the fence side 14. The auxiliary slot 30 may be configured with an element for carrying out an auxiliary operation, which may be related or unrelated to the primary function of the square 10 as will be described herein.

The scribe guide slot 24 includes a pair of opposing edges 32 and 34. The edges 32 and 34 include a number of teeth or projections 36 extending from the respective edge 32 or 34 toward the opposing edge 32 or 34 and perpendicular to an axis defined by the ruler side 12. The projections 36 define a number of scribe guide notches 38 along each of the edges 32 and 34 between the adjacent projections 36 for marking lines on a workpiece. The projections 36 are spaced relative to one another a predetermined distance such as, for example, 0.25 inches, or any other similarly suitable distance. The spacing between the projections 36 extending from the edge 32 and between the projections extending from the edge 34 is identical and the scribe guide notches 38 on the edges 32 and 34 are aligned with one another. Accordingly, the user of the square 10 may easily make a number of markings using the scribe guide notches 38 when moving the square 10 in opposite directions. The scribe guide notches 38 may have varying depths for quick identification by the user. For example, the scribe guide notches 38 at 3.5 and 5.5 inches may be larger than the other scribe guide notches to correspond to the standard widths of 4 and 6 inch wide lumber stock, respectively, and therefore may be frequently used. Of course, it is understood that the scribe guide notches 38 at other locations may be enlarged or otherwise differ from the rest of the scribe guide notches 38 as may be desired. Other means of quickly identifying given scribe guide notches 38 may be employed such as by application of certain indicia to the front and rear surfaces 20 and 22, respectively, of the 10 adjacent the scribe guide notches or by forming scribe guide notches 38 in another configuration that differentiates them from the surrounding scribe guide notches 38.

The user may use the scribe guide notches 38 to mark lines on a given workpiece by positioning the fence element 18 flush against the edge of the workpiece. The fence element 18 includes a pair of flanges 40 and 42 configured to enable the user to arrange the square 10 relative to the workpiece. In particular, one of the edges 40 and 42 may be placed flush against a side of the workpiece while the other may be grasped by the user to maintain the square 10 flush against the edge of the workpiece. Thus, the user may easily maintain the square 10 in a predetermined orientation to ensure proper marking. A pencil or other marking instrument is then inserted into the desired scribe guide notch 38, and the square 10 is slid along the edge of the workpiece in the direction of the edge 32 or 34 in which the pencil or other marking instrument is held while holding the fence element 18 flush against the edge of the workpiece to mark a first line that is parallel to the edge of the workpiece so the user may mark cut or layout lines on the workpiece. As desired, the user of the square 10 may then mark a second line coincident with the first line and also parallel to the edge of the workpiece by moving the marking instrument to the scribe guide notch 38 directly opposite the scribe guide notch 38 used for marking the first line. In this manner, the user of the square is able to mark lines parallel with the edge of the workpiece in opposing direction without repositioning the square 10 as is the case with known squares having offset scribe guide notches.

As previously indicated, the face and bottom sides 20 and 22 may include a number of markings used for carrying out operations with the square 10. The square 10 may include a number of markings extending parallel with the hypotenuse side 16 such as, for example, degree markings 44 located adjacent to the edge defined by the hypotenuse side 16, common markings 46 located adjacent to a side of the rafter slot 26, and hip/val markings 48 located adjacent an opposing side of the rafter slot 26. The degree markings 44 may be configured to enable a user to mark a predetermined angle on the workpiece. The common markings 46 may be configured to enable a user to mark a predetermined slope on the workpiece that corresponds to a configuration associated with a common rafter style. The hip/val markings 48 may be configured to enable a user to mark the workpiece with a predetermined slope corresponding to a configuration associated with a hip/valley style rafter.

Ruler markings 50 may be provided adjacent to and parallel with the ruler side 12. The ruler markings 50 may be provided in inches, centimeters, or the like as may be desired and may be used to enable a user to make measurements and/or mark the measurements of the workpiece. A pivot marking 52 may be provided at an intersection of the ruler side 12 and the fence side 14 and define a pivot point 54 of square 10 during operation.

First, with respect to the degree markings 44, in operation, the user holds the square 10 flush with one of the edges 40 or 42 of the fence element 18 and the workpiece as previously described. The user then rotates the square 10 about the pivot point 54 until the desired angle along the hypotenuse side 16 is aligned with an opposite edge of the workpiece. Once the square 10 is properly aligned, the user may mark or cut the workpiece at the desired angle by marking or cutting along the hypotenuse side 16, which has been rotated to an angle equal to that of the degree marking 44 aligned with the opposite edge of the workpiece relative to the edge of the workpiece.

Next, with respect to the rafter markings, i.e., common markings 46 and hip/val markings 48, in operation, the user holds the square 10 flush with one of the edges 40 or 42 of the fence element 18 and the workpiece as described herein. The user then rotates the square 10 about the pivot point 54 until the desired value of the common or hip/val markings 46 or 48 are aligned with an opposite edge of the workpiece. Once the square 10 is properly aligned, the rafter slot 26 may be utilized to make the appropriate marking according to the desired common or hip/val slope.

The auxiliary slot 30 may include a centrally positioned flange element 56, which may be in the form of a bottle opener element as illustrated. The auxiliary slot 30 may be generally rectangularly shaped and the flange element 56 may project from one edge of the slot 30 toward the opposite edge a predetermined amount such that an object, such as a bottle cap, may be inserted between the flange element 56 and the opposite edge of the slot 30 to thereby allow the 3 flange element 56 to serve as a bottle opener. The flange element 56 may be sized, shaped, and configured to engage, for example, the cap of a bottle or similar object so that pivoting the square 10 about the edge of the slot opposite the flange element 56 removes the cap from the bottle. The auxiliary slot 30 may have any number of alternative constructions and may be disposed at any location on the body of the square 10 as long as it does not interfere with operation of the square 10.

Various alternatives and modifications are contemplated as being within the scope of the following claims particularly pointing out and distinctly claiming the subject matter regarded as the invention.

I claim:

1. A square-type tool comprising:
a plurality of sides;
an aligning arrangement configured to align one of the plurality of sides with an edge of a workpiece;
a scribe arrangement including a plurality of scribe guide notches extending parallel to the aligning arrangement and configured to enable drawing of a line parallel to the aligning arrangement in a first direction and in a second direction opposite the first direction at the same distance from the edge of the workpiece without movement of the tool relative to the workpiece in a direction perpendicular to aligning arrangement.

2. The tool of claim 1, wherein the scribe arrangement is defined by an aperture in the tool.

3. The tool of claim 2, wherein the aperture defines a first edge and a second edge opposite the first edge, wherein each of the first and second edges includes a plurality of projections extending toward the other of the first and second edges and defining the plurality of scribe guide notches between adjacent projections.

4. The tool of claim 3, wherein the scribe guide notches defined along the first edge are aligned with the scribe guide notches along the second edge.

5. The tool of claim 1, wherein the aligning arrangement comprises a fence element.

6. The tool of claim 5, wherein the fence arrangement in combination with one of the plurality of sides defines a T-shaped base.

7. The tool of claim 1, further comprising at least one set of markings configured to enable a user to carry out a measurement with the tool.

8. A square-type tool comprising:
a plurality of sides and a front surface and rear surface;
an aligning arrangement configured to align one of the sides with a workpiece;
a scribe arrangement including a plurality of scribe guide notches that extend parallel to the aligning arrangement to enable drawing of a line parallel to the aligning arrangement;
wherein the scribe guide notches are defined by a first set of teeth extending in a first direction parallel to the aligning arrangement and a second set of teeth extending in a second direction that is opposite the first direction, and wherein the scribe guide notches defined by the first set of teeth and the second set of teeth are aligned with one another and configured to enable marking of an workpiece in first and second opposing directions without repositioning the tool.

9. The tool of claim 8, wherein the scribe arrangement comprises a scribe slot.

10. The tool of claim 8, wherein the aligning arrangement comprises a fence element.

11. The tool of claim 8, wherein the tool comprises a rafter angle square.

12. The tool of claim 8, further comprising at least one set of markings configured for carrying out an operation on the workpiece with the tool.

13. The tool of claim 8, wherein the tool comprises ruler markings.

14. The tool of claim 8, wherein the tool comprises degree markings.

15. The tool of claim 8, further comprising a pivot point.

16. The tool of claim 8, wherein the plurality of sides form an isosceles right triangle including a first side, a fence side, and a hypotenuse side.

17. The tool of claim 8, further comprising an opener element formed in the tool and configured to assist a user in opening an object.

18. A method of using a square-type tool comprising a first side, a second side and a hypotenuse side, wherein the first, second, and hypotenuse sides form a right triangle and a scribe guide slot defined by the tool and including a first edge opposite a second edge wherein a plurality of projections extend from each of the first and second edges toward the other of the first and second edges and define a plurality of scribe guide notches between adjacent projections, the method comprising the steps of:
positioning the rafter angle square tool flush with an edge of a workpiece;
inserting a marking tool into a first scribe guide notch;
moving the tool along the edge of the workpiece in a first direction to form a first mark parallel with the edge of the workpiece;
inserting the marking tool into a second scribe guide notch opposite the first scribe guide notch;
moving the tool along the edge in a second direction opposite the first direction to mark a second line parallel with the edge of the workpiece;
wherein the first and second lines are at an equal distance relative to the edge of the workpiece.

19. The method of claim 18, further comprising the step of pivoting the tool about a pivot point and marking a line at a predetermined angle relative to the edge of the workpiece.

20. The method of claim 18, wherein at least one of the plurality of scribe guide notches includes an indicator element, wherein the indicator element distinguishes the at least one of the plurality of scribe guide notches from the other of the plurality of scribe guide notches.
